(19) United States
(12) Patent Application Publication
(10) Pub. No.: US 2023/0234570 A1
(43) Pub. Date: Jul. 27, 2023

(54) DRIVER ASSISTANCE APPARATUS AND DRIVER ASSISTANCE METHOD

(71) Applicant: HL KLEMOVE CORP., Incheon (KR)

(72) Inventor: Taehan KIM, Anyang-si (KR)

(21) Appl. No.: 18/101,470

(22) Filed: Jan. 25, 2023

(30) Foreign Application Priority Data
Jan. 26, 2022 (KR) 10-2022-0011691

(51) Int. Cl. B60W 30/09; B60W 10/04; B60W 10/10; B60Q 5/00; B60W 10/18; G06V 20/56; G06V 40/20

(52) U.S. Cl. CPC B60W 30/09; B60W 10/04; B60W 10/10; B60Q 5/006; B60W 10/18; G06V 20/56; G06V 40/20; B60W 2540/00; B60W 2556/45; B60W 2420/42; B60W 2710/1005; B60W 2554/4044; B60W 2554/802

(57) ABSTRACT

Disclosed herein is a driver assistance apparatus including a camera which is installed in a vehicle, has a field of view around the vehicle, and is configure to acquire image data, and a controller including a processor configured to process the image data. The controller is configured to identify a gesture corresponding to a predesignated reference gesture based on the image data, and change a gear state of the vehicle and control a driving device of the vehicle to move the vehicle, based on identifying the gesture.

### CROSS-REFERENCE TO RELATED APPLICATION

This application is based on and claims priority under 35 U.S.C. § 119 to Korean Patent Application No. 10-2022-0011691, filed on Jan. 26, 2022 in the Korean Intellectual Property Office, the disclosure of which is incorporated herein by reference.

### BACKGROUND

### 1. Field

Embodiments of the present disclosure relate to a driver assistance apparatus and a driver assistance method, and more particularly, to a driver assistance apparatus of a vehicle in a double-parked state, and a driver assistance method.

### 2. Description of the Related Art

Recently, in order to reduce a driver's burden and improve convenience, research on vehicles equipped with an advanced driver assist system (ADAS) that actively provides information about a vehicle state, a driver condition, and a surrounding environment has been actively conducted, but technology which can solve the following problems associated with conventional double-parked vehicles has not been developed up to now.

Conventionally, when it is impossible to for a vehicle to depart due to a double-parked vehicle, a driver of the vehicle to depart pushes the double-parked vehicle by hand to secure a departure space, or the driver calls the driver of the double-parked vehicle to request the driver to move the position of the double-parked vehicle.

However, when a gear state of a double-parked vehicle is a parking state, and when the double-parked vehicle cannot be pushed, and the driver of the double-parked vehicle cannot immediately move the position of his or her vehicle, in some cases, a conflict may arise. In addition, when a double-parked vehicle is contaminated, discomfort may occur when the driver of a vehicle to depart pushes the double-parked vehicle with the driver's hand.

Furthermore, when a driver of a vehicle to depart pushes and moves a double-parked vehicle, there is a risk of colliding with another double-parked vehicle in the front or rear of the double-parked vehicle.

### SUMMARY

Therefore, it is an aspect of the present disclosure to provide a driver assistance apparatus which controls a position of a vehicle to be moved when a predesignated gesture is identified, and a driver assistance method.

For example, when any driver who desires to depart in the driver's vehicle makes a gesture to move a double-parked vehicle in front of the driver's vehicle, a driver assistance apparatus of a double-parked vehicle and a driver assistance method can control a position of the double-parked vehicle to be moved.

In addition, it is an aspect of the present disclosure to provide a driver assistance apparatus of a vehicle which can, for example, when an approaching object, that is, an approaching vehicle is identified, avoid a collision through a collision warning and/or position movement of a vehicle based on a distance to the object, and a driver assistance method.

For example, when any person pushes and moves a double-parked first vehicle, a driver assistance apparatus of a second vehicle double-parked in front or rear of a first vehicle and a driver assistance method can determine a possibility of collision with the first vehicle to control a collision warning and/or position movement of the second vehicle. A driver assistance apparatus of a double parked second vehicle and a driver assistance method can primarily generate a collision warning based on a distance to a first vehicle and can secondarily control a collision warning and/or position movement of the second vehicle.

Additional aspects of the disclosure will be set forth in part in the description which follows and, in part, will be obvious from the description, or may be learned by practice of the disclosure.

In accordance with one aspect of the present disclosure, a driver assistance apparatus includes a camera which is installed in a vehicle, has a field of view around the vehicle, and is configure to acquire image data, and a controller including a processor configured to process the image data. The controller is configured to identify a gesture corresponding to a predesignated reference gesture based on the image data, and change a gear state of the vehicle and control a driving device of the vehicle to move the vehicle, based on identifying the gesture.

The controller may be configured to control a communicator of the vehicle to transmit a control permission request signal for the vehicle to a predesignated electronic device or a predesignated electronic device server based on identifying the gesture, receive a control permission signal according to response of transmission of the control permission request signal, and change a gear state of the vehicle and control the driving device to move the vehicle, based on the received control permission signal.

The driver assistance apparatus may further include a detector installed in the vehicle to acquire detection data around the vehicle. The controller may be configured to identify whether the vehicle is movable in a first direction by a predesignated reference distance based on at least one of the image data and the detection data in response to identifying the gesture, and change the gear state of the vehicle to correspond to the first direction and control the driving device to move the vehicle in the first direction by the predesignated reference distance, based on the vehicle being movable.

The controller may be configured to identify the first direction based on at least one of the image data or the detection data acquired in a second direction opposite to the first direction.

The camera may include at least one of a first camera having a front field of view of the vehicle and a second camera having a rear field of view of the vehicle. The controller may be configured to control the driving device to move the vehicle backward based on identifying the gesture based on first image data acquired through the first camera, and control the driving device to move the vehicle forward based on identifying the gesture based on second image data acquired through the second camera.

The controller may be configured to change the gear state of the vehicle into a reverse state based on identifying the gesture based on the first image data, and change the gear state of the vehicle into a drive state based on identifying the gesture based on the second image data.

The controller may be configured to change the gear state of the vehicle into a parking state based on the vehicle being moved by a predesignated reference distance.

In accordance with another aspect of the present disclosure, a driver assistance apparatus includes a camera which is installed in a vehicle, has a field of view around the vehicle, and acquires image data, a detector installed in the vehicle to acquire detection data around the vehicle, and a controller including a processor configured to process the image data and the detection data. The controller may be configured to identify an object approaching the vehicle based on at least one of the image data and the detection data, and perform at least one control of control of a speaker of the vehicle which outputs a warning sound, control of a communicator of the vehicle which transmits situation information of the vehicle according to an approach of the object, and control of a driving device which controls movement of the vehicle, based on a distance between the vehicle and the object.

The situation information of the vehicle may include at least one of image data corresponding to the approach of the object and information about the distance between the vehicle and the object.

The controller may be configured to control the speaker to output the warning sound and may control the communicator to transmit the situation information of the vehicle to at least one of a predesignated electronic device and a predesignated server, based on the distance between the vehicle and the object being a predesignated first reference distance.

The controller may be configured to control the driving device to move the vehicle based on the distance between the vehicle and the object being a predesignated second distance that is shorter than the predesignated first reference distance.

The controller may be configured to control the communicator to transmit the situation information of the vehicle to at least one of the predesignated electronic device and the predesignated server based on the distance between the vehicle and the object being the predesignated second distance, receive a control permission signal for the vehicle according to response of transmission of the situation information of the vehicle, and control the driving device to move the vehicle based on receiving the control permission signal.

The control permission signal may include a signal for changing a gear state of the vehicle.

The detector may include at least one of a front radar configured to acquire front detection data of the vehicle and a rear radar configured to acquire rear detection data of the vehicle. The controller may be configured to control the driving device to move the vehicle backward based on identifying the object based on the front detection data, and control the driving device to move the vehicle forward based on identifying the object based on the rear detection data.

The controller may be configured to change a gear state of the vehicle into a reverse state based on a distance between the vehicle and the object identified based on the front detection data being the predesignated second reference distance, and change the gear state of the vehicle into a drive state based on a distance between the vehicle and the object identified based on the rear detection data being the predesignated second reference distance.

The controller may be configured to control a braking device of the vehicle to stop movement of the vehicle based on the distance between the vehicle and the object being longer than a predesignated third distance.

The controller may be configured to change a gear state of the vehicle into a parking state for a predesignated time based on controlling the braking device.

In accordance with still another aspect of the present disclosure, a driver assistance method includes acquiring image data corresponding to a field of view around a vehicle, identifying a gesture corresponding to a predesignated reference gesture based on the image data; and changing a gear state of the vehicle and controlling a driving device of the vehicle to move the vehicle based on identifying the gesture.

The driver assistance method may further include transmitting a control permission request signal for the vehicle to a predesignated electronic device or a predesignated server based on identifying the gesture, and receiving a control permission signal according to response of transmission of the control permission request signal. The controlling of the driving device is performed based on the received control permission signal.

The driver assistance method may further include acquiring detection data around the vehicle. The controlling of the driving device includes identifying whether the vehicle is movable in a first direction by a predesignated reference distance based on at least one of the image data and the detection data based on identifying the gesture, and changing the gear state of the vehicle to correspond to the first direction and controlling the driving device to move the vehicle in the first direction by the predesignated reference distance, based on the vehicle being movable.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 illustrates a configuration of a vehicle according to one embodiment;

FIG. 2 illustrates fields of view of cameras and radars included in a driver assistance apparatus according to one embodiment;

FIG. 3 is a flowchart of a driver assistance operation of a driver assistance apparatus according to one embodiment;

FIGS. 4A and 4B show diagrams illustrating an operation in which a driver assistance apparatus controls movement of a double-parked vehicle according to one embodiment;

FIGS. 5A and 5B show diagrams illustrating an operation in which a driver assistance apparatus controls movement of a double-parked vehicle according to one embodiment;

FIG. 6 is a flowchart of a driver assistance operation of a driver assistance apparatus according to one embodiment; and

FIGS. 7A and 7B show diagrams illustrating an operation in which a driver assistance apparatus avoids a risk of collision due to an approach of another vehicle according to one embodiment of the present disclosure.

### DETAILED DESCRIPTION

Like reference numerals refer to like elements throughout the specification. Not all elements of embodiments of the present disclosure will be described, and description of what are commonly known in the art or what overlap each other in the embodiments will be omitted. The terms as used throughout the specification, such as “part,” “module,” “member,” and “block,” may be implemented in software and/or hardware, and a plurality of “parts,” “modules,” “members,” or “blocks” may be implemented in a single element, or a single “part,” “module,” “member,” or “block” may include a plurality of elements.

It will be understood that when an element is referred to as being “connected” to another element, it can be directly or indirectly connected to another element, wherein the indirect connection includes “connection via a wireless communication network.”

When a part “includes” or “comprises” an element, unless there is a particular description contrary thereto, the part may further include other elements, not excluding the other elements.

Throughout the present specification, the term “on” that is used to designate a position of one element with respect to another element includes both a case that the one element is adjacent to the other element and a case that any other element exists between these two elements.

The terms “first,” “second,” and the like are used to differentiate a certain element from another element, but elements should not be construed to be limited by the terms.

A singular expression includes a plural expression unless the context clearly indicates otherwise.

An identification code is used for convenience of the description but is not intended to illustrate the order of operations. The operations may be implemented in the order different from the illustrated order unless the context clearly indicates otherwise.

The principle and embodiments of the present disclosure will now be described with reference to the accompanying drawings.

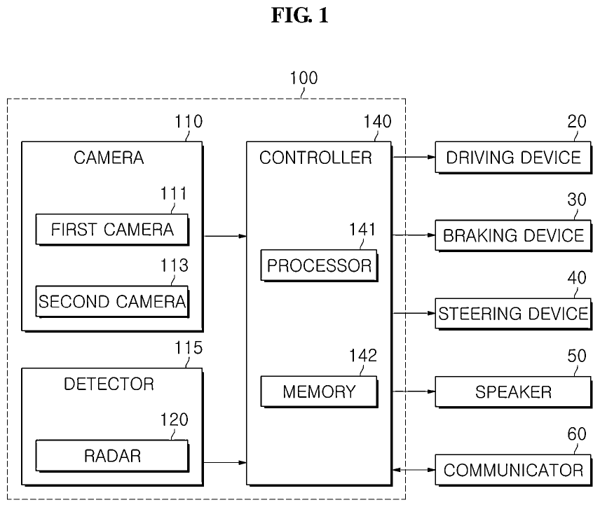

FIG. 1 illustrates a configuration of a vehicle according to one embodiment.

As shown in FIG. 1, a vehicle 1 includes a driving device 20, a braking device 30, a steering device 40, a speaker 50, a communicator 60, and/or a driver assistance apparatus 100. The components may communicate with each other through a vehicle communication network (NT). For example, electric devices 20, 30, 40, 50, 60, and 100 included in the vehicle 1 may exchange data through Ethernet, media oriented systems transport (MOST), FlexRay, a controller area network (CAN), or a local interconnect network (LIN).

The driving device 20 may move the vehicle 1 and may include, for example, an engine, an engine management system (EMS), a transmission, and a transmission controller (TCU).

The engine may generate power for driving the vehicle 1, and the EMS may control the engine in response to an acceleration intention of a driver through an accelerator pedal or a request from the driver assistance apparatus 100.

The transmission may reduce and transmit power generated by the engine to wheels, and the TCU may control the transmission in response to a shift command of a driver through a shift lever and/or a request from the driver assistance apparatus 100.

The braking device 30 may stop the vehicle 1 and may include, for example, an electronic brake caliper and an electronic brake control module (EBCM).

The brake caliper may decelerate or stop the vehicle 1 using friction with a brake disc, and the EMCM may control the brake caliper in response to a braking intention of a user through a brake pedal and/or a request from the driver assistance apparatus 100.

For example, the EBCM may receive a deceleration request including deceleration from the driver assistance apparatus 100 and may electrically or hydraulically control the brake caliper to decelerate the vehicle 1 according to the requested deceleration.

The steering device 40 may include an electronic power steering (EPS) control module.

The steering device 40 may change a driving direction of the vehicle 1, and the EPS control module may assist the operation of the steering device 40 in response to a steering intention of a user through a steering wheel such that the driver may easily operate the steering wheel. Also, the EPS control module may control the steering device in response to a request from the driver assistance apparatus 100. For example, the EPS control module may receive a steering request including steering torque from the driver assistance apparatus 100 and may control the steering device to steer the vehicle 1 according to the requested steering torque.

The speaker 50 may be provided as one or more speakers and may output a sound signal to the inside and/or outside of the vehicle 1.

The communicator 60 (or also referred to as a communication circuit) may construct a wireless and/or wired communication channel between external devices, for example, electronic devices (not shown) or servers (not shown), and may support communication through the constructed communication channel.

For example, the communicator 60 may include a communication circuit.

For example, the communicator 60 may include a wired communication module (for example, a power line communication module) and/or a wireless communication module (for example, a cellular communication module, a Wi-Fi communication module, and/or a short-distance wireless communication module) and may communicate with an external device using a corresponding communication module among the communication modules.

The driver assistance apparatus 100 may provide various functions to a driver. For example, the driver assistance apparatus 100 may provide lane departure warning (LDW), lane keeping assist (LKA), lane following assist, high beam assist (HBA), autonomous emergency braking (AEB), traffic sign recognition (TSR), adaptive cruise control (SCC), blind spot detection (BSD), and the like.

The driver assistance apparatus 100 includes a camera 110, a detector 115, and a controller 140. The detector 115 may include a radar 120. The present disclosure is not limited to that shown in FIG. 1, and the detector 115 may further include a light detection and ranging (LiDAR) which scans a periphery of the vehicle 1 and detects an object.

The camera 110 may include a first camera 111 having a front field of view of the vehicle 1 and/or a second camera 113 having a rear field of view of the vehicle 1.

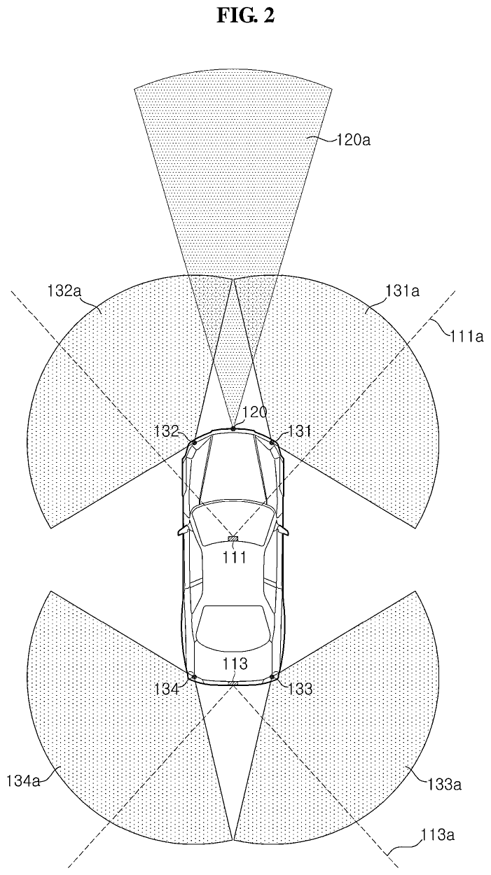

As shown in FIG. 2, the first camera 111 may have a field of view 111a facing a front direction of the vehicle 1. The first camera 111 may be installed, for example, on a front windshield of the vehicle 1.

The first camera 111 may photograph a front view of the vehicle 1 and may acquire image data of the front view of the vehicle 1. The image data of the front view of the vehicle 1 may include information about other vehicles, pedestrians, cyclists, or lanes (markers for distinguishing lanes) positioned in front of the vehicle 1.

The second camera 113 may have a field of view 113a facing a rear direction of the vehicle 1.

The second camera 113 may photograph a rear view of the vehicle 1 and may acquire image data of the rear view of the vehicle 1. The image data of the rear view of the vehicle 1 may include information about other vehicles, pedestrians, cyclists, or lanes positioned in rear of the vehicle 1.

The camera 110 may include at least one lens and an image sensor. A lens holder may include at least one lens. The lens holder accommodates a circuit board, and an image sensor may be mounted on the circuit board. The image sensor may include a plurality of photodiodes that convert light into an electrical signal, and the plurality of photodiodes may be disposed in a two-dimensional matrix.

The camera 110 may be electrically connected to the controller 140. For example, the camera 110 is connected to the controller 140 through the vehicle communication network (NT), may be connected to the controller 140 through a hard wire, or may be connected to the controller 140 through a printed circuit board (PCB). The camera 110 may transmit image data around the vehicle 1, for example, the image data of the front view and/or the image data of the rear view of the vehicle 1 to the controller 140.

As shown in FIG. 2, the radar 120 may include a first radar 121 and/or one or more second radars 131, 132, 133, and 134.

As shown in FIG. 2, the first radar 121 may have a field of sensing 120a facing a front direction of the vehicle 1. The first radar 121 may be installed, for example, on a grill or bumper of the vehicle 1.

The first radar 121 may include a transmitting antenna (or a transmitting antenna array) for radiating transmission radio waves toward the front of the vehicle 1, and a receiving antenna (or a receiving antenna array) for receiving reflected radio waves reflected from an object. The first radar 121 may acquire detection data from a transmission wave transmitted by the transmitting antenna and a reflected wave received by the receiving antenna. The detection data may include distance information and speed information of other vehicles, pedestrians, or cyclists positioned in front of the vehicle 1. The first radar 121 may calculate a state distance to an object based on a phase difference (or time difference) between a transmission radio wave and a reflected radio wave and may calculate a relative speed of the object based on a frequency difference between the transmission radio wave and the reflected radio wave.

The first radar 121 may be connected to the controller 140 through, for example, the vehicle communication network (NT), a hard wire, or a PCB. The first radar 121 may transfer detection data to the controller 140.

The second radars 131, 132, 133, and 134 include a first corner radar 131 installed at a front right side of the vehicle 1, a second corner radar 132 installed at a front left side of the vehicle 1, a third corner radar 133 installed at a rear right side of the vehicle 1, and a fourth corner radar 134 installed at a rear left side of the vehicle 1.

As shown in FIG. 2, the first corner radar 131 may have a field of sensing 131a facing a front-right side of the vehicle 1 and may be installed, for example, at a right side of a front bumper of the vehicle 1. The second corner radar 132 may have a field of sensing 132a facing a front-left side of the vehicle 1 and may be installed, for example, at a left side of the front bumper of the vehicle 1. The third corner radar 133 may have a field of sensing 133a facing a rear-right side of the vehicle 1 and may be installed, for example, at a right side of a rear bumper of the vehicle 1. The fourth corner radar 134 may have a field of sensing 134a facing a rear-left side of the vehicle 1 and may be installed, for example, at a left side of the rear bumper of the vehicle 1.

Each of the first, second, third, and fourth corner radars 131, 132, 133, and 134 may include a transmitting antenna and a receiving antenna. The first, second, third, and fourth corner radars 131, 132, 133, and 134 may acquire first corner detection data, second corner detection data, third corner detection data, and fourth corner detection data, respectively. The first corner detection data may include distance information and speed information of other vehicles, pedestrians, or cyclists (hereinafter referred to as “objects”) positioned in the front-right side of the vehicle 1.

The second corner detection data may include distance information and speed information of objects positioned in the front-right side of the vehicle 1. The third and fourth corner detection data may include distance information and relative speed of objects positioned in the rear-right side of the vehicle 1 and the rear-left side of the vehicle 1.

Each of the first, second, third, and fourth corner radars 131, 132, 133, and 134 may be connected to the controller 140 through, for example, the vehicle communication network (NT), a hard wire, or a PCB. The first, second, third, and fourth corner radars 131, 132, 133, and 134 may transmit the first detection data, the second detection data, the third detection data, and the fourth corner detection data to the controller 140, respectively.

The controller 140 may be electrically connected to the camera 110 and the detector 115. In addition, the controller 140 may be connected to the driving device 20, the braking device 30, the steering device 40, the speaker 50, and the communicator 60 through the vehicle communication network (NT).

The controller 140 may include a processor 141 and a memory 142.

The processor 141 may process image data of the camera 110 and detection data of the detector 115, for example, the radar 120, and may generate a driving signal, a braking signal, and a steering signal for controlling the driving device 20, the braking device 30, and the steering device 40. For example, the processor 141 may include an image processor which processes image data of the camera 110, a digital signal processor which processes detection data of the radar 120, and/or a micro controller (MCU) which generates a driving signal, a braking signal, and a steering signal. An MCU inside a camera system may be disposed to be integrated with an imaging system or may be disposed separately from the imaging system to implement a 2-box system. In addition, an upper integrated controller (DCU) as well as an MCU device may be newly disposed to integrate and control a camera and a radar system.

The processor 141 may detect objects (for example, other vehicles, pedestrians, or cyclists) around the vehicle 1, for example, in front and/or rear of the vehicle 1 based on image data of the camera 110 and detection data of the detector 115, for example, the radar 120.

Based on image data of the camera 110, the processor 141 may obtain relative positions (distances from the vehicle and angles with respect to a driving direction) of objects around the vehicle 1, for example, in front and/or rear of the vehicle 1, and classification (for example, whether an object is another vehicle, a pedestrian, or a cyclist). Based on detection data of the radar 120, the processor 141 may obtain relative positions (distances from the vehicle and angles with respect to a driving direction) and relative speeds of objects around the vehicle 1. In addition, the processor 141 may match objects detected based on detection data with objects detected based on image data and may obtain classification, relative positions, and relative speeds of objects around the vehicle 1 based on matching results.

The processor 141 may generate a driving signal, a braking signal, and a steering signal based on relative positions and relative speeds of objects around the vehicle 1, for example, in front and/or rear of the vehicle 1.

For example, the processor 141 may transmit a driving signal and/or a braking signal to the driving device 20 and/or the braking device 30 such that a distance to a preceding vehicle (or a time until a position of the preceding vehicle is reached) becomes a distance set by a driver. Based on positions (distances) and relative speeds of front objects, the processor 141 may calculate a time to collision (TTC) (or a distance to a collision (TTD) between the vehicle 1 and the front object and may warn a driver of a collision or transmit a braking signal to the braking device 30 based on a comparison between the TTC and a reference value. In addition, when a collision with the front object is determined based on the TTC or the TTD, the processor 141 may transmit a steering signal to the steering device 40 to avoid a collision with the front object.

The processor 141 may control the steering device 40 to assist in steering for avoiding a collision of the vehicle 10 such that the vehicle 1 does not deviate from a target lane. For example, based on an operation of a driver, the processor 141 may minimize a risk of collision that may occur in steering for avoiding a collision of the vehicle 10.

The memory 142 may temporarily store image data received from the camera 110 and/or detection data received from the detector 115, for example, the radar 120, and may temporarily store processing results of the image data and/or the detection data by the processor 141.

The memory 142 may include not only volatile memories such as a static random access memory (S-RAM) and a dynamic random access memory (D-RAM) but also non-volatile memories such as a flash memory, a read only memory (ROM), and an erasable programmable read only memory (EPROM), and the like.

Meanwhile, hereinafter, the first radar 121, the first corner radar 131, and the second corner radar 132 in the above-described embodiment may be referred to as front radars for acquiring front detection data of the vehicle 1. In addition, the third corner radar 133 and the fourth corner radar 134 in the above-described embodiment may be referred to as rear radars for acquiring rear detection data of the vehicle 1.

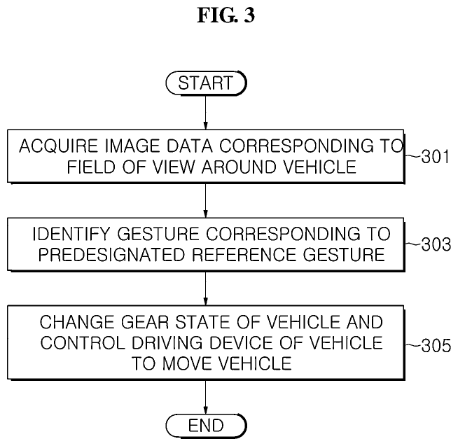

FIG. 3 is a flowchart of a driver assistance operation of a driver assistance apparatus 100 (and/or a controller 140 of the driver assistance apparatus 100) according to one embodiment.

The driver assistance apparatus 100 may acquire image data corresponding to a field of view around a vehicle 1 (301).

The driver assistance apparatus 100 may acquire image data through a first camera 111 having a front field of view of the vehicle 1 and/or a second camera 113 having a rear field of view of the vehicle 1.

The driver assistance apparatus 100 may identify a gesture (or motion) corresponding to a predesignated reference gesture (or also referred to as a reference motion) based on the acquired image data (303).

The identifying of the gesture corresponding to the predesignated reference gesture may be performed by identifying whether acquired image data includes image data of the gesture corresponding to the predesignated reference gesture.

Information about the predesignated reference gesture may be stored in a memory 142 of the driver assistance apparatus 100. For example, the reference gesture may be predesignated in a shape of one hand or both hands of a person who pushes the vehicle 1 and/or an entire shape of a person who pushes the vehicle 1.

Upon identifying the gesture, the driver assistance apparatus 100 may change a gear state of the vehicle 1 and may control a driving device 20 of the vehicle 1 to move the vehicle 1 (305).

Upon identifying the gesture, the driver assistance apparatus 100 may transmit a control permission request signal for the vehicle 1 to a predesignated electronic device or server through a communicator 60 of the vehicle 1.

For example, the electronic device may include a portable terminal of a driver of the vehicle 1 (or also referred to as a user). Also, the server may be a server including an application for controlling the vehicle 1, and the server may provide the control permission request signal to an electronic device of the driver through the application. The driver may know that there is a permission request for controlling the vehicle 1 through an application installed on his or her electronic device.

For example, the control permission request signal may include a permission request signal for controlling the vehicle 1 including changing the vehicle 1 to a turn-on state, changing the gear state of the vehicle 1, and/or controlling movement of the vehicle 1.

The driver assistance apparatus 100 may receive a control permission signal according to response of transmission of the control permission request signal, may change the gear state of the vehicle 1 based on the received control permission signal, and may control the driving device 20 to move the vehicle 1.

For example, when the vehicle 1 is in a turn-off state, based on the received control permission signal, the driver assistance apparatus 100 may turn the vehicle 1 on, may change the gear state of the vehicle 1, and then may control the driving device 20 to move the vehicle 1.

Upon identifying the gesture, the driver assistance apparatus 100 may identify whether the vehicle 1 is able to move in a first direction by a predesignated reference distance.

Based on the image data acquired through a camera 110 and/or the detection data acquired through a detector 115, the driver assistance apparatus 100 may identify whether the vehicle 1 is able to move in the first direction by the predesignated reference distance.

The first direction may be determined based on a direction of a gesture which is identified or a predesignated direction for each gesture.

When a gesture is identified in a second direction opposite (or contrary to) the first direction, the driver assistance apparatus 100 may identify the first direction as a direction in which the vehicle 1 is to move.

When a gesture is identified based on image data and detection data acquired in the second direction opposite to the first direction, the driver assistance apparatus 100 may identify the first direction as a direction in which the vehicle 1 is to move.

When a gesture is identified based on first image data acquired through the first camera 111 having a front field of view of the vehicle 1, the driver assistance apparatus 100 may control the driving device 20 to move the vehicle 1 backward. Upon identifying a gesture on second image data acquired through the second camera 113 having a rear field of view of the vehicle 1, the driver assistance apparatus 100 may control the driving device 20 to move the vehicle 1 forward.

Based on the vehicle 1 being able to move, the driver assistance apparatus 100 may change the gear state of the vehicle 1 to correspond to the first direction and may control the driving device 20 to move the vehicle 1 in the first direction by the predesignated reference distance.

When a gesture is identified in front of the vehicle 1, that is, when a gesture is identified based on the first image data, the driver assistance apparatus 100 may change the gear state of the vehicle 1 into a reverse (R) state in which the vehicle 1 may move backward.

When a gesture is identified in front of the vehicle 1, that is, when a gesture is identified based on the second image data, the driver assistance apparatus 100 may change the gear state of the vehicle 1 into a drive (D) state in which the vehicle 1 may move forward.

Meanwhile, in addition to the above-described embodiment, upon the vehicle 1 being moved by the predesignated reference distance, the driver assistance apparatus 100 may change the gear state of the vehicle 1 into a parking (P) state or a neutral (N) state. In addition, when the vehicle 1 moves according to the above-described operations from in a previous turn-off state, the driver assistance apparatus 100 may turn the vehicle 1 off.

In addition, in the above-described embodiment, although it has been described that the vehicle is moved based on a direction in which a gesture is identified, according to another embodiment, a movement direction of the vehicle 1 may be designated in advance for each of a plurality of reference gestures. When a gesture corresponding to one reference gesture is identified among the plurality of reference gestures, the driver assistance apparatus 100 may cause the vehicle 1 to move in a direction designated in advance according to one reference gesture.

Further, in addition to the above-described embodiment, when it is identified that the vehicle 1 is unable to move in the first direction by the predetermined reference distance, the driver assistance apparatus 100 may control a speaker 50 of the vehicle 1 to output a sound signal notification that the vehicle 1 is unable to move.

In addition, when it is identified that the vehicle 1 is unable to move in the first direction by the predesignated reference distance, the driver assistance apparatus 100 may control the communicator 60 of the vehicle 1 to transmit a signal notification that the vehicle 1 is unable to move to an electronic device and/or a server, thereby allowing the driver of the vehicle 1 to perceive that the driver needs to move the vehicle 1 by the driver's self.

According to the above-described embodiment of FIG. 3, when a driver of a vehicle who desires to depart in the vehicle conventionally moves the double-parked vehicle 1 in front of the driver's vehicle, the driver can easily move the double-parked vehicle 1 through a gesture.

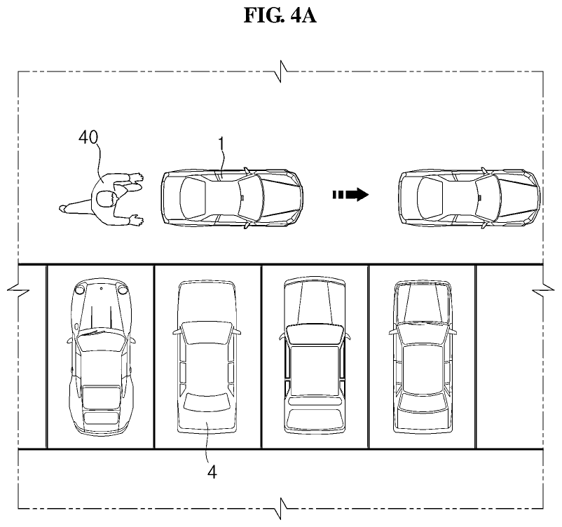

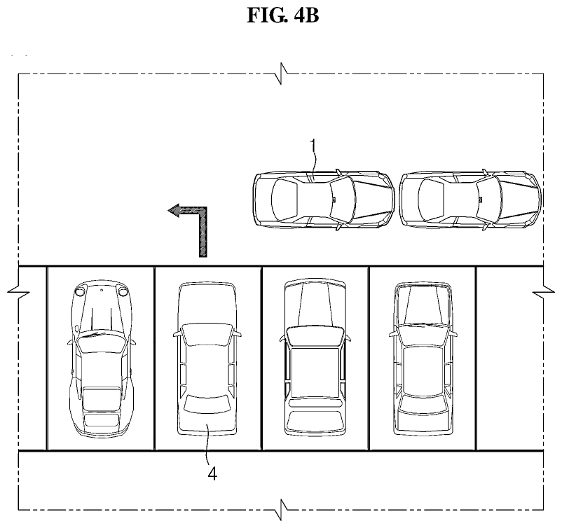

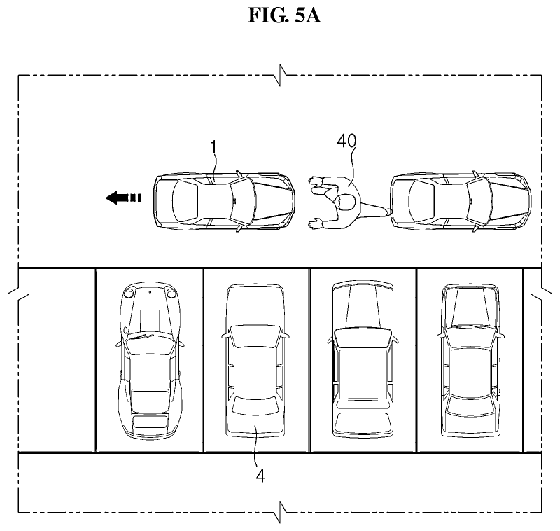

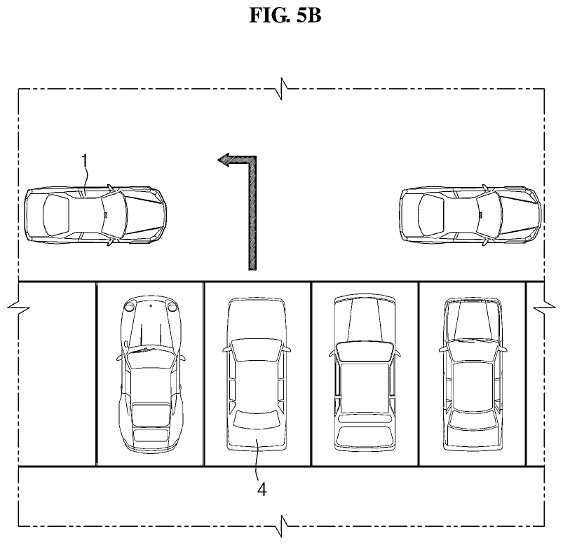

FIGS. 4 and 5 show diagrams illustrating an operation in which a driver assistance apparatus 100 (and/or a controller 140 of the driver assistance apparatus 100) controls movement of a double-parked vehicle 1 according to one embodiment.

Based on double parking recognition according to the operation of a camera 110, a detector 115, and/or other devices of the vehicle 1 and/or an operation of a driver, the driver assistance apparatus 100 of the double-parked vehicle 1 may set the vehicle 1 to a standby mode.

The standby mode may include a mode in which the driver assistance apparatus 100 of the vehicle 1 is set to be able to identify a gesture in a state in which the vehicle 1 is turned off and/or the vehicle 1 is stopped. For example, the standby mode may include a mode of maintaining an on state of the camera 110 of the vehicle 1, for example, a first camera 111 and a second camera 113.

Referring to FIG. 4A, when a driver 40 of a vehicle 4 who desires to depart in the vehicle 4 desires to move the double-parked vehicle 1 forward, as shown in FIG. 4A, the driver 40 may make a gesture of pushing the vehicle 1 in rear of the double-parked vehicle 1.

The driver assistance apparatus 100 of the double-parked vehicle 1 may identify a gesture based on image data acquired through the second camera 113 having a rear field of view and may release the standby mode when identifying the gesture.

For example, upon identifying a gesture, the driver assistance apparatus 100 may transmit a control permission request signal for the vehicle 1 to a predesignated electronic device and/or server. The driver assistance apparatus 100 may release the standby mode based on the control permission request signal for the vehicle 1 received according to response of transmission of the control permission request signal for the vehicle 1.

Upon the standby mode being released, the driver assistance apparatus 100 of the double-parked vehicle 1 may search a space in front of the vehicle 1, that is, identify whether the vehicle 1 is able to move forward by a predesignated reference distance.

When the vehicle 1 is able to move forward by the predesignated reference distance, the driver assistance apparatus 100 of the double-parked vehicle 1 may change a gear state of the vehicle 1 from a parking state to a drive state. For example, when the vehicle 1 is in a turn-off state, the driver assistance apparatus 100 may turn the vehicle 1 on and then change the gear state of the vehicle 1 from the parking state to the drive state.

Thereafter, the driver assistance apparatus 100 of the double-parked vehicle 1 may control a driving device 20 of the vehicle 1 to move the vehicle 1 forward the predesignated reference distance (for example, up to 3 m).

In addition, when the vehicle 1 moves the predesignated reference distance, the driver assistance apparatus 100 of the double-parked vehicle 1 may control a braking device 30 of the vehicle 1 to stop movement of the vehicle 1.

In addition, the driver assistance apparatus 100 of the double-parked vehicle 1 may change the gear state of the vehicle 1 into the parking state. For example, when the vehicle 1 has been in a turn-off state before moving, the driver assistance apparatus 100 may change the gear state of the vehicle 1 into the parking state and then turn the vehicle 1 off.

The driver assistance apparatus 100 of the stopped vehicle 1 may reset the vehicle 1 to a double-parking standby mode.

As a position of the double-parked vehicle 1 is moved, as shown in FIG. 4B, the driver of the vehicle 4 may depart in the vehicle 4.

Referring to FIG. 5A, when the driver 40 of the vehicle 4 who desires to depart in the vehicle 4 desires to move the double-parked vehicle 1 backward, as shown in FIG. 5A, the driver 40 may make a gesture of pushing the vehicle 1 in front of the double-parked vehicle 1.

The driver assistance apparatus 100 of the double-parked vehicle 1 may identify a gesture based on image data acquired through the first camera 111 having a front field of view and may release the standby mode upon identifying the gesture.

For example, the driver assistance apparatus 100 may transmit a control permission request signal for the vehicle 1 to a predesignated electronic device and/or server when identifying the gesture. The driver assistance apparatus 100 may release the standby mode based on the control permission request signal for the vehicle 1 received according to response of transmission of the control permission request signal for the vehicle 1.

Upon the standby mode being released, the driver assistance apparatus 100 of the double-parked vehicle 1 may search a space in rear of the vehicle 1, that is, identify whether the vehicle 1 is able to move backward by a predesignated reference distance.

When the vehicle 1 is able to move backward by the predesignated reference distance, the driver assistance apparatus 100 of the double-parked vehicle 1 may change a gear state of the vehicle 1 from a parking state to a reverse state. For example, when the vehicle 1 is in a turn-off state, the driver assistance apparatus 100 may turn the vehicle 1 on and then change the gear state of the vehicle 1 from the parking state to the reverse state.

Thereafter, the driver assistance apparatus 100 of the double-parked vehicle 1 may control the driving device 20 of the vehicle 1 to move the vehicle 1 backward the predesignated reference distance (for example, up to 3 m).

In addition, when the vehicle 1 moves the predesignated reference distance, the driver assistance apparatus 100 of the double-parked vehicle 1 may control the braking device 30 of the vehicle 1 to stop movement of the vehicle 1.

The driver assistance apparatus 100 of the stopped vehicle 1 may reset the vehicle 1 to the standby mode.

For example, the driver assistance apparatus 100 of the double-parked vehicle 1 may change the gear state of the vehicle 1 into the parking state. For example, when the vehicle 1 has been in a turn-off state before moving, the driver assistance apparatus 100 may change the gear state of the vehicle 1 into the parking state and then turn the vehicle 1 off.

As a position of the double-parked vehicle 1 is moved, as shown in FIG. 5B, the driver of the vehicle 4 may depart in the vehicle 4.

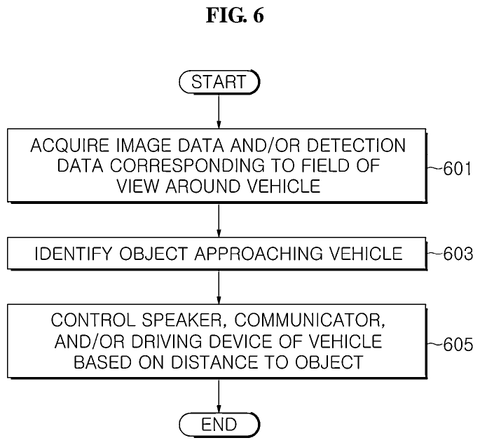

FIG. 6 is a flowchart of a driver assistance operation of a driver assistance apparatus 100 (and/or a controller 140 of the driver assistance apparatus 100) according to one embodiment.

The driver assistance apparatus 100 may acquire image data and/or detection data corresponding to a field of view around a vehicle 1 (601).

The driver assistance apparatus 100 may acquire image data through a first camera 111 having a front field of view of the vehicle 1 and/or a second camera 113 having a rear field of view of the vehicle 1.

The driver assistance apparatus 100 may acquire detection data through front radars 121, 131, and 132 and/or rear radars 133 and 134.

The driver assistance apparatus 100 may identify an object approaching the vehicle 1 based on the image data and/or the detection data (603).

For example, the object approaching the vehicle 1 may include a vehicle.

The driver assistance apparatus 100 may control a speaker 50, a communicator 60, and/or a driving device 20 of the vehicle 1 based on a distance between the vehicle 1 and the object (605).

The driver assistance apparatus 100 may control the speaker 50 of the vehicle 1 to output a predesignated warning sound based on the distance between the vehicle 1 and the object.

The driver assistance apparatus 100 may control the communicator 60 of the vehicle 1 to transmit situation information of the vehicle 1 based on the distance between the vehicle 1 and the object. For example, the situation information of the vehicle 1 may include image data corresponding to an approach of the object and/or information about the distance between the vehicle 1 and the object.

The driver assistance apparatus 100 may control the driving device 20 of the vehicle 1 to move the vehicle 1 based on the distance between the vehicle 1 and the object.

Based on the distance between the vehicle 1 and the object being a predesignated first reference distance, the driver assistance apparatus 100 may control the speaker 50 of the vehicle 1 to output the predesignated warning sound and may control the communicator 60 to transmit the situation information of the vehicle 1 to a predesignated electronic device and/or server.

For example, the electronic device may include a portable terminal of a driver (or also referred to as a user) of the vehicle 1. Also, the server may be a server including an application for controlling the vehicle 1, and the server may provide the situation information of the vehicle 1 to an electronic device of the driver through the application. The driver may check the situation information of the vehicle 1 through an application installed on the driver's electronic device.

Base on the distance between the vehicle 1 and the object being a predesignated second reference distance shorter than the predesignated first reference distance, the driver assistance apparatus 100 may control the driving device 20 to move the vehicle 1. Based on the distance between the vehicle 1 and the object being the predesignated second reference distance shorter than the predesignated first reference distance, the driver assistance apparatus 100 may control the communicator 60 to transmit the situation information of the vehicle 1 to the predesignated electronic device and/or server and/or may control the speaker 50 to output the predesignated warning sound.

For example, based on the distance between the vehicle 1 and the object being the predesignated second reference distance, the driver assistance apparatus 100 may control the communicator 60 to transmit the situation information of the vehicle 1 to the predesignated electronic device and/or server.

According to response of transmission of the situation information of the vehicle 1, the driver assistance apparatus 100 may receive a control permission signal for the vehicle 1 from the electronic device and/or the server through the communicator 60. For example, the control permission signal for the vehicle 1 may include a permission request signal for controlling the vehicle 1 including changing the vehicle 1 to a turn-on state, changing a gear state of the vehicle 1, and/or controlling movement of the vehicle 1.

The driver assistance apparatus 100 may control the driving device 20 to move the vehicle 1 based on the reception of the control permission signal for the vehicle 1.

The driver assistance apparatus 100 may control the driving device 20 to move the vehicle 1 based on a direction in which an object is identified.

When an object is identified in front of the vehicle 1, that is, when an object is identified based on front detection data acquired through the front radars 121, 131, and 132, the driver assistance apparatus 100 may control the driving device 20 to move the vehicle 1 backward.

Based on a distance between the vehicle 1 and the object identified based on the front detection data being the predesignated second reference distance, the driver assistance apparatus 100 may change the gear state of the vehicle 1 into a reverse state and control the driving device 20 to move the vehicle 1 backward.

When an object is identified in rear of the vehicle 1, that is, when an object is identified based on rear detection data acquired through the rear radars 133 and 134, the driver assistance apparatus 100 may control the driving device 20 to move the vehicle 1 forward.

For example, based on a distance between the vehicle 1 and the object identified based on the rear detection data being the predesignated second reference distance, the driver assistance apparatus 100 may change the gear state of the vehicle 1 into a drive state and control the driving device 20 to move the vehicle 1 forward.

Based on the distance between the vehicle and the object being longer than a predesignated third reference distance, the driver assistance apparatus 100 may control a braking device 30 of the vehicle 1 to stop movement of the vehicle 1. For example, the predesignated third reference distance may be longer than or equal to the predesignated second reference distance.

Based on control of the braking device 30 to stop the movement of the vehicle 1, the driver assistance apparatus 100 may change the gear state of the vehicle 1 into a parking state.

According to the above-described embodiment of FIG. 6, in a state in which a plurality of vehicles are double-parted conventionally, when a driver pushes and moves a vehicle, a front or rear vehicle 1 positioned in a movement direction may identify a risk of collision and output a warning sound and/or move when there is a risk of collision.

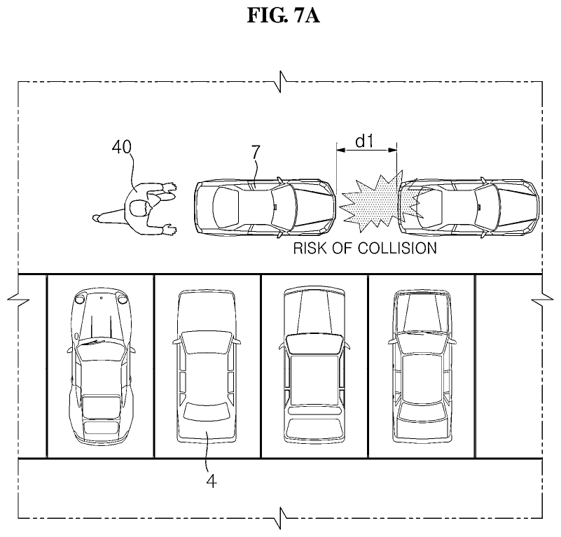

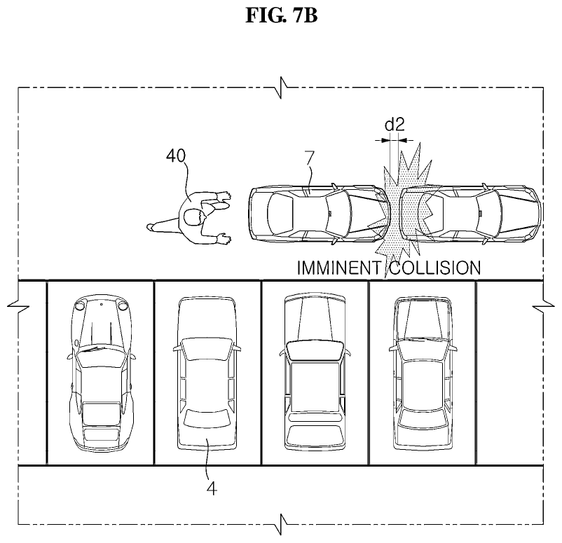

FIG. 7 shows diagrams illustrating an operation in which a driver assistance apparatus 100 (and/or a controller 140 of the driver assistance apparatus 100) avoids a risk of collision due to an approach of another vehicle according to one embodiment of the present disclosure.

Based on double parking recognition according to the operation of a camera 110, a detector 115, and/or other devices of the vehicle 1 and/or an operation of a driver, the driver assistance apparatus 100 of a double-parked vehicle 1 may set the vehicle 1 to a standby mode.

The standby mode may include a mode in which the driver assistance apparatus 100 of the vehicle 1 is set to be able to identify an approach of an object in a state in which the vehicle 1 is turned off and/or the vehicle 1 is stopped. For example, the standby mode may include a mode of maintaining an on state of the camera 110 and/or the detector 115 of the vehicle 1.

Referring to FIGS. 7A and 7B, a driver 40 of a vehicle 4 who desires to depart in the vehicle 4 may push a double-parked vehicle 7 to move the vehicle 7. The driver assistance apparatus 100 of the vehicle 1 double-parked in a movement direction of the vehicle 7 may identify the vehicle 7 moved to approach the vehicle 1 as a target vehicle.

The driver assistance apparatus 100 may release a standby mode based on the identification of the target vehicle.

Upon the standby mode being released, the driver assistance apparatus 100 may identify whether a distance between the approaching vehicle 7 and the vehicle 1 is a predesignated first reference distance d1 at which it is determined that there is a risk of collision.

When it is identified that the distance between the approaching vehicle 7 and the vehicle 1 is the predesignated first reference distance d1 as shown in FIG. 7A, the driver assistance apparatus 100 may output a predesignated warning sound through a speaker 50 of the vehicle 1 and may also transmit situation information to a predesignated electronic device and/or server through a communicator 60.

When it is identified that the distance between the approaching vehicle 7 and the vehicle 1 is a predesignated second reference distance d2 at which it is determined that a collision is imminent as shown in FIG. 7B, the driver assistance apparatus 100 may output the predesignated warning sound through the speaker 50 of the vehicle 1, may transmit situation information to the predesignated electronic device and/or server through the communicator 60, and may control a driving device 20 to move the vehicle 1.

For example, based on the distance between the approaching vehicle 7 and the vehicle 1 being the predesignated second reference distance, the driver assistance apparatus 100 may control the communicator 60 to transmit the situation information of the vehicle 1 to the predesignated electronic device and/or server. According to response of transmission of the situation information, the driver assistance apparatus 100 may receive a control permission signal for the vehicle 1 from the electronic device and/or the server. The driver assistance apparatus 100 may control the driving device 20 to move the vehicle 1 based on the reception of the control permission signal for the vehicle 1.

For example, as shown in FIG. 7, when the vehicle 7 approaches the rear of the vehicle 1, that is, the approaching vehicle 7 is identified through a second camera 113 having a rear field of view and/or rear radars 133 and 134 acquiring rear detection data, the driver assistance apparatus 100 may change a gear state of the vehicle 1 from a parking state or a neutral state to a drive state and may control the driving device 20 to control the vehicle 1 to move forward.

For example, although not shown, when the vehicle 7 approaches the rear of the vehicle 1, that is, the approaching vehicle 7 is identified through a first camera 111 having a front field of view and/or front radars 121, 131, and 132 acquiring front detection data, the driver assistance apparatus 100 may change the gear state of the vehicle 1 from the parking state or the neutral state to a reverse state and may control the driving device 20 to control the vehicle 1 to move backward.

When a collision risk situation due to an approach to the vehicle 1 is released, the driver assistance apparatus 100 may change the vehicle 1 to a standby mode.

For example, the driver assistance apparatus 100 of the double-parked vehicle 1 may change the gear state of the vehicle 1 into the parking state. For example, when the vehicle 1 has been in a turn-off state off before moving, the driver assistance apparatus 100 may change the gear state of the vehicle 1 into the parking state and then turn the vehicle 1 off.

According to a driver assistance apparatus of a vehicle and a driver assistance method according to an aspect of the present disclosure, there is provided a driver assistance apparatus allowing a position of a vehicle to be moved when a gesture is identified, and a driver assistance method.

For example, according to a driver assistance apparatus of a double-parked vehicle and a driver assistance method, any driver who desires to depart in the driver's vehicle can easily move a double-parked vehicle in front of the driver's vehicle with only a gesture so that a problem caused by conventional position movement of the double-parked vehicle can be solved.

According to a driver assistance apparatus of a vehicle and a driver assistance method according to an aspect of the present disclosure, when an approaching object is identified, a collision with the object can be avoided through a collision warning and/or position movement of a vehicle based on a distance to the object.

For example, according to a driver assistance apparatus of a double-parked vehicle and a driver assistance method, a possibility of collision with a vehicle approaching from the front or rear can be determined to reduce a risk of collision with the approaching vehicle through a collision warning and/or position movement of a double-parked vehicle.

Meanwhile, the disclosed embodiments can be implemented with recording media storing computer-executable instructions. The instructions can be stored in the form of program code and generate, when executed by a processor, a program module such that the operation of the disclosed embodiments can be performed. The recording media can be implemented as computer-readable recording media.

The computer-readable recording media include all types of recording media in which instructions that can be interpreted by a computer are stored. Examples of the computer-readable recording media include a ROM, a RAM, a magnetic tape, a magnetic disk, a flash memory, an optical data storage device, and the like.

The disclosed embodiments have been described above with reference to the accompanying drawings. Those of ordinary skill in the art to which the present disclosure pertains will appreciate that the present disclosure can be carried out in forms different from the disclosed embodiments without changing the technical spirit or essential characteristics of the present disclosure. The disclosed embodiments are exemplary and should not be interpreted as restrictive.

What is claimed is:

1. A driver assistance apparatus comprising:
a camera installed in a vehicle, having a field of view around the vehicle, and configured to acquire image data; and
a controller including a processor configured to process the image data,
wherein the controller is configured to:
identify a gesture corresponding to a predesignated reference gesture based on the image data; and
upon identifying the gesture, change a gear state of the vehicle and control a driving device of the vehicle to move the vehicle.

2. The driver assistance apparatus of claim, 1, wherein the controller is configured to:
upon identifying the gesture, control a communicator of the vehicle to transmit a control permission request signal for the vehicle to a predesignated electronic device or a predesignated server;
receive a control permission signal according to response of transmission of the control permission request signal; and
based on the received control permission signal, change a gear state of the vehicle and control the driving device to move the vehicle.

3. The driver assistance apparatus of claim 1, further comprising a detector installed in the vehicle to acquire detection data around the vehicle,
wherein the controller is configure to:
based on identifying the gesture, identify whether the vehicle is movable in a first direction by a predesignated reference distance based on at least one of the image data and the detection data; and
based on the vehicle being movable, change the gear state of the vehicle to correspond to the first direction and control the driving device to move the vehicle in the first direction by the predesignated reference distance.

4. The driver assistance apparatus of claim 3, wherein the controller is configured to identify the first direction based on at least one of the image data or the detection data acquired in a second direction opposite to the first direction.

5. The driver assistance apparatus of claim 1, wherein the camera includes at least one of a first camera having a front field of view of the vehicle and a second camera having a rear field of view of the vehicle, and
the controller is configured to:
based on identifying the gesture based on first image data acquired through the first camera, control the driving device to move the vehicle backward; and
based on identifying the gesture based on second image data acquired through the second camera, control the driving device to move the vehicle forward.

6. The driver assistance apparatus of claim 5, wherein the controller is configured to:
based on identifying the gesture based on the first image data, change the gear state of the vehicle into a reverse state; and
based on identifying the gesture based on the second image data, change the gear state of the vehicle into a drive state.

7. The driver assistance apparatus of claim 1, wherein the controller is configured to, based on the vehicle being moved by a predesignated reference distance, change the gear state of the vehicle into a parking state.

8. A driver assistance apparatus comprising:
a camera installed in a vehicle, having a field of view around the vehicle, and configured to acquire image data;
a detector installed in the vehicle to acquire detection data around the vehicle; and
a controller including a processor configured to process the image data and the detection data,
wherein the controller is configured to:
identify an object approaching the vehicle based on at least one of the image data and the detection data; and
based on a distance between the vehicle and the object, perform at least one control of control of a speaker of the vehicle which outputs a warning sound, control of a communicator of the vehicle which transmits situation information of the vehicle according to an approach of the object, and control of a driving device which controls movement of the vehicle.

9. The driver assistance apparatus of claim 8, wherein the situation information of the vehicle includes at least one of image data corresponding to the approach of the object and information about the distance between the vehicle and the object.

10. The driver assistance apparatus of claim 8, wherein the controller is configured to, based on the distance between the vehicle and the object being a predesignated first reference distance, control the speaker to output the warning sound and control the communicator to transmit the situation information of the vehicle to at least one of a predesignated electronic device and a predesignated server.

11. The driver assistance apparatus of claim 10, wherein the controller is configured to, based on the distance between the vehicle and the object being a predesignated second distance that is shorter than the predesignated first reference distance, control the driving device to move the vehicle.

12. The driver assistance apparatus of claim 11, wherein the controller is configured to:
based on the distance between the vehicle and the object being the predesignated second distance, control the communicator to transmit the situation information of the vehicle to at least one of the predesignated electronic device and the predesignated server;
according to response of transmission of the situation information of the vehicle, receive a control permission signal for the vehicle; and
based on receiving the control permission signal, control the driving device to move the vehicle.

13. The driver assistance apparatus of claim 12, wherein the control permission signal includes a signal for changing a gear state of the vehicle.

14. The driver assistance apparatus of claim 12, wherein the detector includes at least one of a front radar configured to acquire front detection data of the vehicle and a rear radar configured to acquire rear detection data of the vehicle,
the controller is configured to:
based on identifying the object based on the front detection data, control the driving device to move the vehicle backward; and
based on identifying the object based on the rear detection data, control the driving device to move the vehicle forward.

15. The driver assistance apparatus of claim 14, wherein the controller is configured to:
based on a distance between the vehicle and the object identified based on the front detection data being the predesignated second reference distance, change a gear state of the vehicle into a reverse state; and
based on a distance between the vehicle and the object identified based on the rear detection data being the predesignated second reference distance, change the gear state of the vehicle into a drive state.

16. The driver assistance apparatus of claim 12, wherein the controller is configured to, based on the distance between the vehicle and the object being longer than a predesignated third distance, control a braking device of the vehicle to stop movement of the vehicle.

17. The driver assistance apparatus of claim 16, wherein the controller is configured to, based on controlling the braking device, change a gear state of the vehicle into a parking state for a predesignated time.

18. A driver assistance method comprising:
acquiring image data corresponding to a field of view around a vehicle;
identifying a gesture corresponding to a predesignated reference gesture based on the image data; and
based on identifying the gesture, changing a gear state of the vehicle and controlling a driving device of the vehicle to move the vehicle.

19. The driver assistance method of 18, further comprising:
based on identifying the gesture, transmitting a control permission request signal for the vehicle to a predesignated electronic device or predesignated server; and
according to response of transmission of the control permission request signal, receiving a control permission signal,
wherein the controlling of the driving device is performed based on the received control permission signal.

20. The driver assistance method of 18, further comprising acquiring detection data around the vehicle,
wherein the controlling of the driving device includes:
based on identifying the gesture, identifying whether the vehicle is movable in a first direction by a predesignated reference distance based on at least one of the image data and the detection data; and
based on the vehicle being movable, changing the gear state of the vehicle to correspond to the first direction and controlling the driving device to move the vehicle in the first direction by the predesignated reference distance.
